(19) United States
(12) Patent Application Publication
(10) Pub. No.: US 2013/0081721 A1
(43) Pub. Date: Apr. 4, 2013

(54) EXHAUST-DOWNPIPE FOR VEHICLE

(71) Applicants: Sung Mu CHOI, Seongnam-si (KR); Jong Hag KIM, Suwon-si (KR); Jong Hwa JUNG, Ulsan (KR)

(72) Inventors: Sung Mu CHOI, Seongnam-si (KR); Jong Hag KIM, Suwon-si (KR); Jong Hwa JUNG, Ulsan (KR)

(73) Assignees: Sejong Ind. Co., Ltd., Ulsan (KR); Hyundai Motor Company, Seoul (KR)

(21) Appl. No.: 13/323,501

(22) Filed: Dec. 12, 2011

(30) Foreign Application Priority Data
Sep. 30, 2011 (KR) 10-2011-0099608

(51) Int. Cl. F15D 1/00

(52) U.S. Cl. 137/583

(57) ABSTRACT

An exhaust-downpipe of a vehicle may include a base portion connected to a top of a catalyst converter having a vertical cylinder, an inlet circularly opened in a horizontal direction, an introduction round portion extending straight along the horizontal direction from the inlet and then and curvedly bent downward toward the base portion, and branch line portions connected to both outsides above the base portion with both ways branching and drawing a circular arc from the introduction round portion.

### CROSS-REFERENCE TO RELATED APPLICATION

The present application claims priority to Korean Patent Application No. 10-2011-0099608, filed on Sep. 30, 2011, the entire contents of which is incorporated herein for all purposes by this reference.

### BACKGROUND OF THE INVENTION

1. Field of the Invention

The present invention relates to a structure of an exhaust-downpipe connecting a turbo charger to a catalyst converter.

2. Description of Related Art

FIG. 1 shows an exhaust-downpipe 500 for a vehicle in a prior art and the exhaust-downpipe 500 acts as a passage supplying discharge gas discharged from a turbocharger 502 to a catalyst converter 504.

In the exhaust-downpipe 500, it is advantageous to improve purification efficiency of a catalyst carrier by introducing the discharge gas discharged from the turbocharger 502 to the catalyst carrier of the catalyst converter 504 in an uniform distribution if possible.

However, when the catalyst converter 504 is mounted so as to be adjacent to an engine block in a narrow engine room, it is impossible to adequately lengthen a passage from the turbo charger 502 to the catalyst converter 504, thereby limiting the length of the exhaust-downpipe 500 to be short. Therefore, when the length of the exhaust-downpipe 500 is short, it is disadvantageous to the uniformity of the discharge gas.

The exhaust-downpipe 500 of FIG. 1 includes a pipe 506 and a diffuser 508 having a cone, and the exhaust gas passing through the pipe 506 is intended to be a uniform flow at the diffuser 508. However, the whole length of the diffuser 508 is relatively short, uniformly causing the flow of the exhaust gas to depend on the volume thereof only and therefore, there is limit which allows rotation components discharged from the turbo charger 502 to form a strong uniform flow.

The details of the background technology related to the invention are only intended to promote a better understanding about the background of the invention, and should be not taken as already known prior art to one skilled in the art.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an exhaust-downpipe for a vehicle capable of maximizing purification efficiency of a catalyst converter by supplying gas discharged from a turbo charger to the catalyst converter in a more uniform flowing state, when disposing a catalyst converter so as to be adjacent to a turbo charger.

In an aspect of the present invention, an exhaust-downpipe of a vehicle, may include a base portion connected to a top of a catalyst converter having a vertical cylinder, an inlet circularly opened in a horizontal direction, an introduction round portion extending straight along the horizontal direction from the inlet and then and curvedly bent downward toward the base portion, and branch line portions connected to both outsides above the base portion with both ways branching and drawing a circular arc from the introduction round portion.

The base portion is formed in a conical shape to become narrow upward from the outside above the catalyst converter.

The introduction round portion extends straight along the horizontal direction from the inlet and then, is bent downwardly while forming the circular arc, and the radius of curvature of the circular arc is set to be 5 to 30% of the length based on the diameter of the catalyst converter.

The round volume portion forming a sphere is formed in the middle of the circular arc forming the branch line portions, and a diameter of the sphere formed with the round volume portion is set to be 20 to 40% of the length based on the diameter of the catalyst converter.

The base portion is formed in a conical shape to become narrow upward from the outside above the catalyst converter, and an angle of the conical side is set to be 0 to 60° toward the center of the base portion from a vertical line thereof.

The inlet is positioned above the base portion, and the introduction round portion is formed to be extended from the inlet to the outside of the catalyst converter extended in an upward direction.

The branch line portions extend to be inclined downwardly from the introduction round portion and then, extend to form the circular arc horizontally and the two branch line portions may have a structure in which the portions extending to form the circular arc in a horizontal direction are formed to be relatively crossed from each other vertically.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows an exhaust-downpipe for a vehicle in a prior art.

FIG. 2 shows a structure of the exhaust-downpipe for the vehicle according to the invention.

FIG. 3 in three dimensions shows the inside space of the exhaust-downpipe of FIG. 2.

FIG. 4 is the right side view of FIG. 3.

FIG. 5 shows exhaust gas flow for the exhaust-downpipe according to the invention.

FIG. 6 shows degree of uniformity of flow for the exhaust gas introduced to a catalyst converter according to the invention.

FIG. 7 shows the exhaust gas flow of the exhaust-downpipe in the prior art.

FIG. 8 shows degree of uniformity of flow for the exhaust gas introduced to the catalyst converter in the prior art.

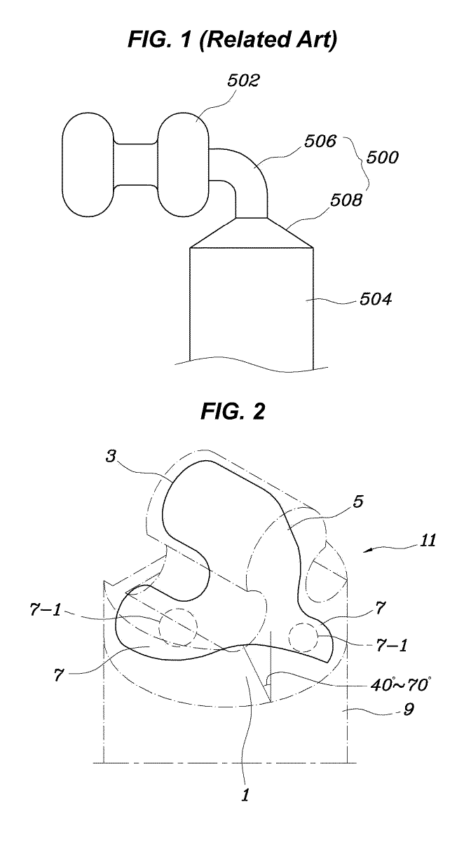

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

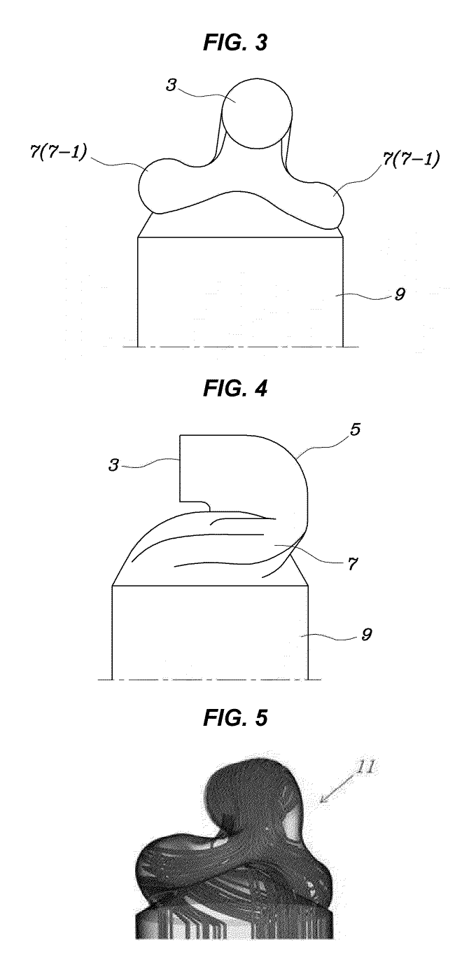

In FIG. 2 to FIG. 4, an exhaust-downpipe 11 of the vehicle according to an exemplary embodiment of the invention is formed to have a space provided therein, the space including: a base portion 1 connected to a top of catalyst converter 9 having a vertical cylinder, an inlet 3 circularly opened in a horizontal direction, an introduction round portion 5 extending straight along the horizontal direction from the inlet 3 and then, curvedly bent downward toward the base portion 1, and branch line portions 7 connected to both outsides above the base portion 1 while drawing a smooth circular arc from the introduction round portion 5.

That is, exhaust gas, discharged by a turbo charger, having rotation components and introduced through the inlet 3 flows horizontally and downwardly changes direction thereof by the introduction round portion 5, subsequently, is branched in both ways and flows along the branch line portions 7 so that the rotation components are offset from each other, thereby preventing a phenomenon causing the flow to concentrate in some part, and forming a uniform flow.

The introduction round portion 5 extends straight along the horizontal direction from the inlet 3 and then, is bent downwardly while forming the circular arc. The radius of curvature of the circular arc is set to be 5 to 30% of the length based on the diameter of the catalyst converter 9.

A round volume portion 7-1 forming a sphere is formed in the middle of the circular arc forming the branch line portions 7, and a diameter of the sphere formed with the round volume portion 7-1 is set to be 20 to 40% of the length based on the diameter of the catalyst converter 9.

The base portion 1 is formed in a conical shape to become narrow upward from the outside above the catalyst converter 9, and an angle of a conical side is set to be 0 to 60° toward the center of the base portion 1 from a vertical line thereof.

The introduction round portion 5, the branch line portions 7 and the base portion 1 have a size limit which is optimized so as to show an optimal effect in the structure as above by adjacently arranging the turbo charger and the catalyst converter 9 within a narrow engine room, and when departing such a limit, degree of uniformity of the flow for the exhaust gas as described above is lowered.

The inlet 3 is positioned above the base portion 1, and the introduction round portion 5 is a structure to be extended from the inlet 3 to the outside of the catalyst converter 9 extended in an upward direction.

The branch line portions 7 extend to be inclined downwardly from the introduction round portion 5 and then, extend to form the circular arc horizontally. Two branch line portions 7 have a structure in which the portions extending to form the circular arc in a horizontal direction are formed to be relatively crossed from each other vertically.

As mentioned above, when using the exhaust-downpipe having the space configured by the inlet 3, the introduction round portion 5, the branch line portions 7 and the base portion 1 therein, the degree of uniformity of flow shown as compared with FIG. 5 is significantly improved compared with a prior art, which maximizes purification efficiency of a catalyst carrier, thereby significantly reducing an emissions level of hazardous substances of the exhaust gas or reducing a size of the catalyst carrier to contribute to cost reduction.

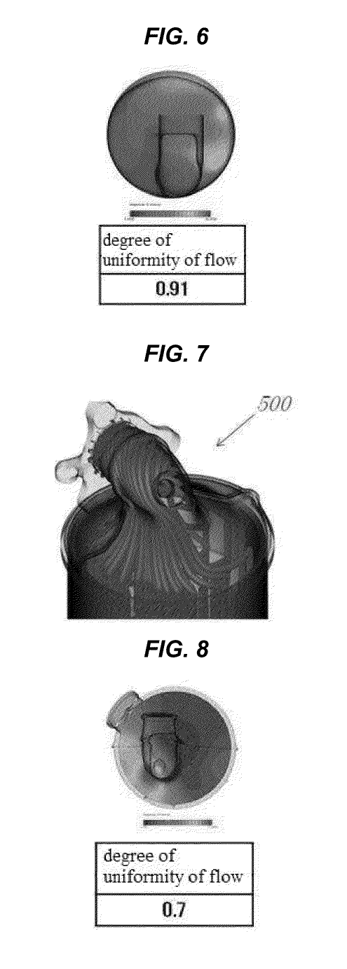

Referring to the drawings showing the action according to the prior art of FIG. 7 and FIG. 8, the flow of the exhaust gas is shifted to one side by the rotation components thereof, such that the degree of uniformity of the horizontal cross-section appears to be only 0.7. However, in the invention shown in FIG. 5 and FIG. 6, the flow of the exhaust gas is both ways branched by the introduction round portion 5 and the branch line portions 7 and then, the branched flows are offset from each other while meeting again, thereby improving the degree of uniformity of the horizontal cross-section thereof up to 0.91 in the base portion 1.

In an exemplary embodiment of the present invention, when disposing a catalyst converter so as to be adjacent to a turbo charger, purification efficiency of the catalyst converter may be maximized by supplying the gas discharged from a turbocharger to the catalyst converter in a more uniform flowing state.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust-downpipe of a vehicle, comprising:
a base portion connected to a top of a catalyst converter having a vertical cylinder;
an inlet circularly opened in a horizontal direction;
an introduction round portion extending straight along the horizontal direction from the inlet and then and curvedly bent downward toward the base portion; and
branch line portions connected to both outsides above the base portion with both ways branching and drawing a circular arc from the introduction round portion.

2. The exhaust-downpipe of the vehicle of claim 1, wherein the base portion is formed in a conical shape to become narrow upward from the outside above the catalyst converter.

3. The exhaust-downpipe of the vehicle of claim 1, wherein the introduction round portion extends straight along the horizontal direction from the inlet and then, is bent downwardly while forming the circular arc, and the radius of curvature of the circular arc is set to be 5 to 30% of the length based on the diameter of the catalyst converter.

4. The exhaust-downpipe of the vehicle of claim 1, wherein the round volume portion forming a sphere is formed in the middle of the circular arc forming the branch line portions, and a diameter of the sphere formed with the round volume portion is set to be 20 to 40% of the length based on the diameter of the catalyst converter.

5. The exhaust-downpipe of the vehicle of claim 1, wherein the base portion is formed in a conical shape to become narrow upward from the outside above the catalyst converter, and an angle of the conical side is set to be 0 to 60° toward the center of the base portion from a vertical line thereof.

6. The exhaust-downpipe of the vehicle of claim 1, wherein the inlet is positioned above the base portion, and the introduction round portion is formed to be extended from the inlet to the outside of the catalyst converter extended in an upward direction.

7. The exhaust-downpipe of the vehicle of claim 1, wherein the branch line portions extend to be inclined downwardly from the introduction round portion and then, extend to form the circular arc horizontally and the two branch line portions have a structure in which the portions extending to form the circular arc in a horizontal direction are formed to be relatively crossed from each other vertically.
